(19) United States
(12) Patent Application Publication
(10) Pub. No.: US 2019/0289875 A1
(43) Pub. Date: Sep. 26, 2019

(54) Process and Device for Producing and Delivering Espresso Ice-Cream, Disposable Ice-Cream Base Container for Such Device and System for Producing and Delivering Espresso Ice-Cream

(71) Applicants: Giovanni Crivello, Poirino (IT); Mario Sacchetto, Lagnasco (IT)

(72) Inventors: Giovanni Crivello, Poirino (IT); Mario Sacchetto, Lagnasco (IT)

(21) Appl. No.: 16/317,148

(22) PCT Filed: Jun. 28, 2017
(86) PCT No.: PCT/IT2017/000132

§ 371 Date: Jan. 11, 2019

(30) Foreign Application Priority Data
Jul. 11, 2016 (IT) 102016000072110

(51) Int. Cl. A23G 9/28; A23G 9/22; A23G 9/42; A23G 9/52; A23G 9/30; B65D 85/804

(52) U.S. Cl. CPC A23G 9/28; A23G 9/228; A23G 9/42; A23V 2002/00; A23G 9/305; B65D 85/804; A23G 9/52

(57) ABSTRACT

A device (1) is described, for producing and delivering ice-cream comprising creaming means (3) for producing such ice-cream (2) starting from at least one ice-cream base; supplying means (5) of at least one of the ice-cream bases to the creaming means (3); cooling means (7) of the creaming means (3); delivering means (9) of the ice-cream (2) from the creaming means (3) outside the device (1). A disposable container (9) of ice-cream base for this device (1) and a system for producing and delivering espresso ice-cream are also described.

The present invention refers to a device for producing and delivering espresso ice-cream, to a disposable ice-cream base container for such device and to a system for producing and delivering espresso ice-cream.

As known, numerous machines are present in the art for preparing ice-creams at artisanal and industrial use.

Machines for domestic use are then known, which mimic artisanal processes through stirrers and fresh ingredients, such as, for example, milk and fruit, till a mixture is obtained to be cooled in a refrigerator: the time required for producing ice-cream through such known machines for domestic use is however relatively long.

Machines are also known for delivering ice-creams of the “soft” type through the solubilization with water of specific bases composed of semi-finished products as mixtures of soluble powders and the following cooling of the thereby-produced paste.

Other types of machines for domestic use mimic this process by using capsules containing a preparation of ice-cream capable of being solubilized: such machines however require the use of a flow of fluid, water or milk, which solubilizes such ice-cream preparation, making such machines particularly complex and costly, as well as making an ice-cream which is very different from the really artisanal one.

Therefore, object of the present invention is solving the above prior art problems by providing a device for producing and delivering espresso ice-cream which does not require the use of a flow of fluid, water or milk, to solubilize the ice-cream preparation.

Another object of the present invention is providing a disposable ice-cream base container for a device for producing and delivering espresso ice-cream.

Moreover, an object of the present invention is providing a system comprising a device and a disposable container for producing an espresso ice-cream which is substantially identical to the artisanal one, but is produced in extremely short times.

The above and other objects and advantages of the invention, as will appear from the following description, are obtained with a device for producing and delivering espresso ice-cream as claimed in claim 1.

Moreover, the above and other objects and advantages of the invention are obtained with a container and a system for producing and delivering espresso ice-cream as claimed in claims 7 and 9, respectively.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention as appears from the enclosed claims.

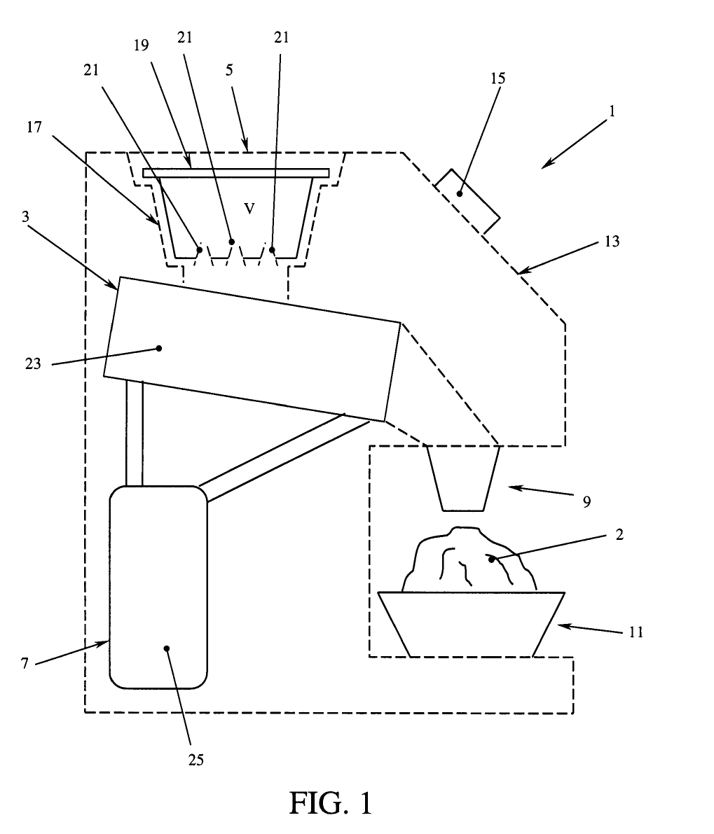

The present invention will be better described by some preferred embodiments thereof, provided as a non-limiting example, with reference to the enclosed drawing, in which the only FIG. 1 shows a schematic side sectional view of a preferred embodiment of a device for producing and delivering espresso ice-cream according to the present invention.

With reference then to FIG. 1, it is possible to note that the device 1 for producing and delivering espresso ice-cream according to the present invention comprises:
creaming means 3 for producing ice-cream 2 starting from at least one ice-cream base;
supplying means 5 of at least one of such ice-cream bases to such creaming means 3;
cooling means 7 of such creaming means 3;
delivering means 9 of such ice-cream 2 from such creaming means 3 outside such device 1, for example inside any container such as, for example, a cone, a waffle or a cup 11.

Obviously, it will be wholly clear to a skilled person in the art that, where necessary, the above means will be mutually fluid connected by the most suitable connecting means, such as ducts, pipes, etc., to allow the passage of the ice-cream base or of ice-cream between the means themselves.

In particular, the device 1 according to the present invention further comprises at least one containing shell 13 of the above means 3, 5, 7, 9 equipped with suitable control means 15 which allow a user, mechanically (for example through a lever or a cock) and/or by interposing for example the most suitable processing means (such as, for example, a microprocessor), to control the operation of the device 1 according to the present invention and to set the various delivering modes of the ice-cream 2.

In particular, the supplying means 5 can comprise at least one tank (not shown), for example accessible from outside the containing shell 13, inside which the user can arrange the ice-cream base to be used for producing the ice-cream 2.

Alternatively or in addition, the supplying means 5 can be adapted to keep in fluid communication at least one external container 19, for example of the disposable type and made of various materials, such as plastics, polyesters, Tetrapak®, aluminum, etc.), containing therein at least one of such ice-cream bases with the creaming means 3: in this case, such supplying means 5 can comprise at least one seat 17, for example accessible from outside the containing shell 13, adapted to house therein at least one of such containers 19 and to put it in fluid connection with the creaming means 3. The seat 17 can therefore comprise opening means 21 (such as, for example, drilling and/or tearing means) of such container to enable the fluid connection between the internal volume V of such container 19 inside which the ice-cream base and the creaming means 3 are present. In particular, once having opened the container 19 with the opening means 21, the ice-cream base can flow and reach from the internal volume V to the creaming means 3 through mere drop, Alternatively or in addition, the device 1 could comprise sucking means (not shown) adapted to extract by suction the ice-cream base from the internal volume V of the container 19 to convey it inside the creaming means 3.

Obviously, it is possible to provide that the container 19, once used, is removed every time manually from the seat 17 or automatically conveyed into a suitable collection chamber (not shown) with which the device 1 according to the present invention can be equipped, such chamber being obviously able to be emptied from outside the containing shell 13.

In particular, the creaming means 3 can comprise at least one creaming device 23 adapted to indifferently perform a creaming of the traditional, continuous or discontinuous ice-cream base.

Preferably, the cooling means 7 of the creaming means 3 comprise at least one compressor 25 having an adequate power to allow forming ice-cream inside such creaming means 3 in relatively very short times.

The gas used by the compressor 25 (latest-generation freon), following its compression, followed by expansion and related cold production, will in turn be cooled by one or more radiators (not shown) crossed by ambient air.

Preferably, the ice-cream base used by the device 1 according to the present invention, either an ice-cream or fruit sorbet or a cream-type ice-cream, is a flash-pasteurized ice-cream base preferably obtained through the above described process comprising the steps of:
preparing a mixture comprising at least one main ingredient in an amount included between 40% and 85% and complementary ingredients in an amount completing 100%, where such complementary ingredients comprise at least one amount of sugar or of one or more sugar syrups in a varying percentage depending on the taste and the consistency that has to be obtained;
subjecting such mixture to a flash-pasteurization process to obtain a flash-pasteurized ice-cream base.

The step of subjecting the mixture to the flash-pasteurization process, aimed in particular to block the enzymatic charge of the mixture itself, preferably comprises the sub-steps of:
pre-heating the mixture up to a temperature included between 90° C. and 110° C. with following thermal flash of such mixture through heating up to a temperature included between 120° C. and 140° C. for a time included between 3 s and 6 s;
afterwards cooling the mixture with flash cooling with a temperature jump included between 35° C. and 55° C. for a time included between 10 s and 25 s.

Moreover, such complementary ingredients can comprise at least one natural thickener chosen, for example, between legumes flours, maize amid derivatives, sunflower liposomes.

In particular, if the mixture is used for preparing an ice-cream base or fruit sorbet, at least one main ingredient is advantageously composed of fresh fruits or semi-finished fresh fruits, previously cleaned, peeled, reeled-off and more or less refined (depending on the desired granulometry) and the amount of such main ingredient composed of fresh fruits can be included between 40% and 85% depending on the desired type and consistency.

Moreover, if the mixture is used for preparing an ice-cream base or fruit sorbet, the amount of sugar or of one or more sugar syrups can be included between 10% and 40%.

Moreover, if the mixture is used for preparing an ice-cream base or fruit sorbet, such complementary ingredients can comprise at least one taste and/or acidity exalting agent chosen, for example, between ascorbic acid or citric acid.

Moreover, if the mixture is used for preparing an ice-cream base or fruit sorbet, such complementary ingredients can comprise at least one amount of milk and/or albumen in order to make the mixture more creamy.

In particular, if the mixture is instead used for preparing a cream-based ice-cream, at least one main ingredient is advantageously composed of at least one taste ingredient among the most various ones: for example, such taste ingredient can be chosen among chocolate, coffee, hazelnut, nougat, meringue, etc. The amount of such main ingredient composed of at least one of such taste ingredients can be included between 40% and 60%. Moreover, if the mixture is used for preparing a cream-based ice-cream, such complementary ingredients comprise at least one amount of milk and/or cream included between 40% and 60% and at least one amount of eggs.

The present invention further deals with a disposable container 19 of an ice-cream base, either an ice-cream or fruit sorbet or a cream ice-cream, for a device 1 for producing and delivering espresso ice-cream as previously described. Advantageously, the ice-cream base contained inside the disposable container 19 according to the present invention is a flash-pasteurized ice-cream base, preferably obtained through the above described process.

In particular, the disposable container 19 according to the present invention can be preferably composed of any vacuum container, sterile and impermeable to light and gas which, together with the use of the step of flash-pasteurizing the mixture, allows obtaining a storage period of the base obtained according to the process of the present invention which is longer than 12 months.

Preferably, therefore, the storage container can be an aluminized multi-layer bag or container of the “Tetra Pak”® type with various sizes or any visible food container.

As further alternative, as shown for example in particular in FIG. 1, the storage container can be composed of a capsule, of a type substantially known in the art, aimed to be used in a delivering device.

The present invention further deals with a system for producing and delivering espresso ice-cream comprising at least one device 1 and at least one disposable container 19 as previously described.

1. Apparatus for preparing an ice-cream base to be used in a device (1) for preparing an ice-cream or fruit sorbet, the base having previously been obtained through the steps of:
preparing a mixture comprising at least one main ingredient in an amount between 40% and 85% and complementary ingredients in an amount completing 100%, said at least one main ingredient being composed of either fresh fruits or semi-finished fresh fruits, said complementary ingredients comprising either sugar or sugar syrups;
subjecting the mixture to a flash-pasteurization process to obtain a flash-pasteurized ice-cream base, said step of subjecting the mixture to the flash-pasteurization process comprising the sub-steps of:
pre-heating the mixture up to a temperature between 90° C. and 110° C. followed by heating the mixture up to a temperature between 120° C. and 140° C. for a time between 3 s and 6 s; and
cooling the mixture with flash cooling by between 35° C. and 55° C. for a time between 10 s and 25 s;
wherein said device (1) for producing and delivering ice-cream comprises:
creaming means (3) for producing said ice-cream (2) starting from at least one of said ice-cream bases;
supplying means (5) of at least one of said ice-cream bases to said creaming means (3);
cooling means (7) of said creaming means (3); and
delivering means (9) of said ice-cream (2) from said creaming means (3) outside said device (1).

2. Apparatus according to claim 1, wherein said device (1) comprises at least one containing shell (13) of said means (3, 5, 7, 9), said shell (13) being equipped with control means (15) to control an operation of said device (1) and a delivery of said ice-cream (2).

3. Apparatus according to claim 1, wherein said supplying means (5) comprises at least one tank of said ice-cream base.

4. Apparatus according to claim 1, wherein said supplying means (5) is configured to put in fluid communication at least one container (19) containing therein at least one of said ice-cream bases with said creaming means (3).

5. Apparatus according to claim 4, wherein said supplying means (5) comprises at least one seat (17) adapted to house inside it at least one of said containers (19) and to put it in fluid connection with said creaming means (3).

6. Apparatus according to claim 5, wherein said seat (17) comprises opening means (21) of said container to enable the fluid connection between an internal volume (V) of said container (19) inside which there is said ice-cream base and said creaming means (3).

7. A disposable container (19) of an ice-cream base comprising either an ice-cream or a fruit sorbet or a cream-type ice-cream, for a device (1) comprising:
creaming means (3) for producing said ice-cream (2) starting from at least one of said ice-cream bases;
supplying means (5) of at least one of said ice-cream bases to said creaming means (3);
cooling means (7) of said creaming means (3); and
delivering means (9) of said ice-cream (2) from said creaming means (3) outside said device (1);
wherein the ice-cream base is a flash-pasteurized ice-cream base.

8. The disposable container (19) according to the claim 7, composed of a capsule.

9. Apparatus for producing and delivering espresso ice-cream comprising:
creaming means (3) for producing said ice-cream (2) starting from at least one of said ice-cream bases;
supplying means (5) of at least one of said ice-cream bases to said creaming means (3);
cooling means (7) of said creaming means (3); and
delivering means (9) of said ice-cream (2) from said creaming means (3) outside said device (1).
